(19) United States
(12) Patent Application Publication
(10) Pub. No.: US 2010/0239485 A1
(43) Pub. Date: Sep. 23, 2010

(54) METHOD OF MANUFACTURING FLUORINATED GAS COMPOUNDS AND APPARATUS FOR MANUFACTURING THE SAME

(75) Inventors: Hisao Tanaka, Yamaguchi (JP); Isamu Mori, Yamaguchi (JP); Kenji Tanaka, Yamaguchi (JP)

Correspondence Address: BUCHANAN, INGERSOLL & ROONEY PC, POST OFFICE BOX 1404, ALEXANDRIA, VA, 22313-1404, US

(73) Assignee: CENTRAL GLASS CO., LTD., YAMAGUCHI (JP)

(21) Appl. No.: 12/740,386

(22) PCT Filed: Dec. 19, 2008
(86) PCT No.: PCT/JP2008/073178

§ 371 Date: Apr. 29, 2010

(30) Foreign Application Priority Data
Dec. 27, 2007 (JP) 2007-337326

(51) Int. Cl. C01B 21/083; B01J 19/00; C01B 7/24

(52) U.S. Cl. 423/351; 422/198

(57) ABSTRACT

An apparatus of generating fluorinated gas compounds by means of reacting liquid stock with gaseous material is characterized by providing a circulating system comprised of a reaction chamber where a liquid mixture containing the liquid stock reacts with the gaseous material, a fluid conduit through which the liquid mixture alone flows, an upper fluid channel through which the reacted liquid mixture moves from the top of the reaction chamber to the top of the fluid conduit, and a lower fluid channel through which the liquid mixture moves from the bottom of the fluid conduit to the bottom of the reaction chamber, and sparging into the bottom of the reaction chamber (A) the virgin gaseous material and (B) at least one selected from the fluorinated gas compounds resulted from the reaction in the reaction chamber, including the first fluorinated gas product generated in the first cycle of the reaction and the second or later gas product resulted from further fluorinating the first or later gas product in the succeeding cycle, so as to circulate the liquid mixture.

### TECHNICAL FIELD

Fluorinated gas compounds such as NF₃, IF₅, IF₇, ClF₃, WF₆ and the like are typically used as a detergent to clean inside of semiconductor fabricating apparatuses such as CVD and PVD apparatuses. A variety of methods for effective production of such gas compounds still have been of great concern in the industry. The above-mentioned gas compounds of NF₃, IF₅, IF₇, ClF₃, and WF₆ are all reaction-completed fluorides to which reference is made by example in the present invention.

### BACKGROUND ART

The applicants of the present invention disclose, for instance, a method of reacting liquidized ammonium complexes with gaseous interhalogenated substances such as ClF₃ to compose gaseous nitride halides as represented by a composition formula of NFₓL₃₋ₓ(L may be any of halides other than F, satisfying 1≦x≦3) (e.g., see Patent Document 1 listed below). The nitride halides are fluorinated during the succeeding treatment(s) and converted to NF₃. Such gaseous fluorinated compounds are preferably generated in successive generation procedures for their respective efficient productions. The term ‘successive’ used herein expresses feeding raw materials without intermittence while a devised system is working, so as to cause a reaction(s) as desired and produce functional gases. The fluorinated compounds are typically generated by a reaction(s) of a gas stock with a non-gas raw material(s). For example, Patent Document 1 teaches the reaction of a liquid stock L with a gaseous material.

In order to efficiently conduct successive productions in the aforementioned conditions, the liquid stock L must be continuously supplied to a reaction chamber where the liquid stock L is to react with the gaseous material. A method of continuously supplying the liquid stock L to the reaction chamber is disclosed in which the principle of bubble column reactors is applied in circulating liquid ammonium acid fluoride in a basin (e.g., see Patent Document 2 listed below). In Patent Document 2, the liquid ammonium acid fluoride reacts with gaseous fluoride to produce NF₃. A circulation of the liquid ammonium acid fluoride, namely, a flow of the liquid is resulted from directing into the basin bubble jet of HF that would not be involved with the reaction series.

In some prior art technology, disclosed is a process where part of gases resulted from a reaction is fed back to a reaction chamber and then reused as a fluid source of a reactant substance to circulate, and in such a process, a retainable biological catalyst is used to convert some components in liquid waste into solid products that easily disgregate from the remaining, so as to facilitate a biological treatment of the liquid waste. The process comprises the steps of:

(a) feeding liquid waste to one or more inlets/nozzles to direct a flow of the liquid waste, one or more outlets/nozzles to drain refined water out, one or more draft tubes, one or more inlets/nozzles located inside the draft tubes to sparge gas and/or air and bubble them up in the draft tubes, and a reaction vessel having a bed deposited with microbe-coated particles,
(b) keeping the liquid waste infiltrated into the bed of microbe-coated particles to convert some components in the liquid waste into solids,
(c) aerating the liquid in the draft tubes by means of the gas and/or air sparged through the nozzles to direct the liquid upward in the draft tubes,
(d) unsticking the self-floating solid products from the bed of microbe-coated particles and evacuating the reaction vessel of the liquid thus treated so far, continually if desired, and
(e) eliminating the solid of the particles from the bottom of the reaction vessel, continually if desired (e.g., see Patent Document 3 listed below).

As another prior art technology embodiment where part of gases resulted from a reaction is fed back to a reaction chamber and reused as a fluid source of a reactant to circulate, disclosed is a liquid waste treatment apparatus that has a reaction basin and septa vertically extended from the upper middle of an inner wall of the reaction basin with an orifice conducting with the basin so as to separate a reaction cell inside the septa from the outside to which depositions are to drop through the orifice. The apparatus also has air-lifting partitions extended in the reaction basin where a carrier-suspending liquid is aerated by air sparged into the bottom of the partitions so as to force suspended carriers to flow upward and cause microorganisms attached to the surface of the carriers to biodegrade liquid waste supplied to the reaction basin. The air-lifting partitions have their respective upper portion provided with a movable shield which is moved up and down to adjust a level of its upper edge so as to control turbulence flows of the liquid, thereby facilitating biological coating over the suspended carriers (see Patent Document 4 listed below).

### Patent Document 1

WO2007/04409

### Patent Document 2

Japanese Preliminary Publication of Unexamined Patent Application No. 2003-238122

### Patent Document 3

Japanese Preliminary Publication of Unexamined Patent Application No. 2004-526561

### Patent Document 4

Japanese Preliminary Publication of Unexamined Patent Application No. H02-135195

### DISCLOSURE OF THE INVENTION

### Problems to be Solved by the Invention

In a method of generating nitride trifluorides disclosed in Patent Document 2, coolers such as a coiled pipe cooler are located on an outer wall of the reactor so that heat of reaction almost equivalent to heat of HF vaporization is dissipated by an HF recovery device. Also, in this method described in Patent Document 2, a sink to which fluids are supplied, namely, a reactor 20 is shaped non-linear but just like an urn unlike the present invention, and hence, the reactor 20 must be increased in capacity as is required to scale gas production up. The reactor 20 of the greater capacity cannot keep the liquids therein at a uniform predetermined temperature, and the costs of equipment and manufacturing are accordingly increased to cope with it. It is necessary to keep a reaction system at 100 degrees Celsius or higher to vaporize HF in an environment where ammonium acid fluoride exists, and the above-mentioned disadvantage with the reactor of the increased capacity becomes innegligibly elicited.

A reaction container 1 used in applying a process disclosed in Patent Document 3 to the method of generating fluorinated gas compounds is also shaped non-linear just like an urn. Thus, the reaction container 1 must be greater in capacity in an attempt to scale the gas production up, resulting the similar disadvantages to those of the embodiment in Patent Document 2.

In the event of applying a process disclosed in Patent Document 4 to the method of generating fluorinated gas compounds, a reaction basin 22 in Patent Document 4 is shaped non-linear just like an urn unlike the present invention, and the attempt to scale up the gas production necessitates increase in the capacity of the reaction basin 22, leading to the similar disadvantages to those of the embodiment in Patent Document 2.

### OBJECT OF THE INVENTION

The present invention, namely, a method of generating fluorinated gas compounds and an apparatus for the same, is made to overcome the aforementioned disadvantages in the prior art method of generating nitrogen trifluorides and another prior art method of feeding part of gases resulted from a reaction back to a reaction chamber and reusing it as a fluid source of a reactant substance to succeedingly circulate, and accordingly, it is an object of the present invention to provide a method and apparatus of generating fluorinated gas compounds that is simple in structure and reduced in risk of malfunctions, and allows for more efficient chemical reactions.

### Means to Solve the Problems

In a first aspect of the present invention, a method of generating fluorinated gas compounds by means of reacting liquid stock with gaseous material is characterized by

providing a circulating system comprised of a reaction chamber where a liquid mixture containing the liquid stock reacts with the gaseous material, a fluid conduit through which the liquid mixture alone flows, an upper fluid channel through which the reacted liquid mixture moves from the top of the reaction chamber to the top of the fluid conduit, and a lower fluid channel through which the liquid mixture moves from the bottom of the fluid conduit to the bottom of the reaction chamber, and

sparging into the bottom of the reaction chamber (A) the virgin gaseous material and (B) at least one selected from the fluorinated gas compounds resulted from the reaction in the reaction chamber, including the first fluorinated gas product generated in the first cycle of the reaction and the second or later gas product resulted from further fluorinating the first or later gas product in the succeeding cycle, so as to circulate the liquid mixture.

When the gaseous material is sparged into the liquid stock L, the gaseous material reacts with the liquid stock L. During the reaction, co-existence of liquid with gas does not so significantly cause apparent relative density to reduce, and consequently, it generates merely an insufficient propulsive force to cause a circulation of the liquid in the circulating system.

Sparging into the bottom of the reaction chamber not only the virgin gaseous material but at least one selected from the fluorinated gas compounds such as the first fluorinated gas product resulted from the first cycle of the reaction in the reaction chamber, the second fluorinated gas product resulted from further fluorinating the first gas product in the second cycle and so forth ensures the reduction in the apparent relative density by virtue of the co-existence of the liquid with the gas.

The latest reaction product or the fluorinated gas compound, if it can afford to be further fluorinated, may be still reactive and therefore less stable. In such a case, the reaction product or the fluorinated gas compound is prone to deteriorate parts such as vessels and/or ducts in the course of feeding it back to the bottom of the reaction chamber. Thus, in order to operate the apparatus stably, the gas compound sparged along with the virgin gaseous material, which is desired to degrade reactivity of the latter, is preferably the reaction gas product twice or more fluorinated after the first cycle of the reaction.

The preferred embodiment in the first aspect of the present invention can be implemented as follows:

In the fluid conduit or a region below the reaction chamber, the liquid mixture undergoes temperature adjustment. In such a manner, valid temperature controls of the liquid mixture efficiently facilitates generating the fluorinated gas compounds.

In addition, such a temperature adjustment region located below the reaction chamber into which the virgin gaseous material and the reaction gas products are sparged desirably permits the gas and the liquid to flow in the same direction, thereby upgrading circulation efficiency of the liquid.

The gaseous material preferably includes interhalogenated substances. In this way, when the liquid stock L of some complex compound is combined with the interhalogenated substances, for example, the interhalogenated substances (e.g., ClF₃) as a virgin material added to the liquid stock L, lets interhalogenated gas dissolve into the liquid stock L as much as allowed depending on its solubility in the liquid stock L. This causes the gaseous material to react with the liquid stock L, which further causes the reaction product liquidized from the gaseous material to react with the liquid stock L, thereby enabling efficient progression of the reaction. As a consequence of the gaseous material dissolving into the liquid stock L, co-existence of the liquid with the gas does not so significantly cause apparent relative density to reduce, and eventually, it generates merely an insufficient propulsive force to cause a circulation of the liquid in the circulating system. The invention's approach includes an attempt to sparge the reaction product or the fluorinated gas compound as well into the bottom of the reaction chamber, so as to facilitate the circulation of the liquid in the circulation system.

In a second aspect of the present invention, an apparatus of generating fluorinated gas compounds by means of reacting liquid stock with gaseous material is characterized by

providing a circulating system comprised of a reaction chamber where a liquid mixture containing the liquid stock reacts with the gaseous material, a fluid conduit through which the liquid mixture alone flows, an upper fluid channel through which the reacted liquid mixture moves from the top of the reaction chamber to the top of the fluid conduit, and a lower fluid channel through which the liquid mixture moves from the bottom of the fluid conduit to the bottom of the reaction chamber, and

providing a gas port unit through which sparged into the bottom of the reaction chamber are the virgin gaseous material and at least one selected from the fluorinated gas compounds resulted from the reaction in the reaction chamber, including the first fluorinated gas product generated in the first cycle of the reaction and the second gas product resulted from further fluorinating the first gas product in the succeeding cycle.

The preferred embodiment in the second aspect of the present invention can be implemented as follows:

In the fluid conduit or a region below the reaction chamber, a liquid temperature control means is located so that the liquid mixture undergoes temperature adjustment therein. In such a manner, valid temperature controls of the liquid mixture efficiently facilitates generating the fluorinated gas compounds.

### EFFECTS OF THE INVENTION

The method and apparatus of generating fluorinated gas compounds in accordance with the present invention is simple in architecture and reduced in risk of malfunctions, and efficiently facilitates a fluorinating reaction.

### BEST MODE OF IMPLEMENTING THE INVENTION

### Embodiment 1

A first preferred embodiment of an apparatus for generating fluorinated gas compounds according to the present invention will now be described in conjunction with the accompanying drawings. FIG. 1 is a side view of the first embodiment of the fluorinated gas compound generating apparatus 10. FIG. 2 is a plan view of the fluorinated gas compound generating apparatus 10. FIG. 3 is a horizontal sectional view showing a return column cooler. FIG. 4 is a sectional view of an enlarged part of a sparging port of a reactant or a gaseous material in FIG. 1. FIG. 5 is a vertical sectional view of a nozzle of the reactant or the gaseous material.

### <Configuration of the Apparatus>

The apparatus 10 for generating fluorinated gas compounds is, as shown in FIG. 1, comprised of a vertical cylindrical column reactor 12, a separating basin 16 having its bottom conductively coupled to the top of the column reactor 12 to disgregate liquid from gas, and a return column cooler 20 conductively coupled to the bottom of the separating basin 16 and extending downward therefrom. Fluids including NH₄F-nHF circulate through the column reactor 12, the separating basin 16, and the return column cooler 20 successively.

The separating basin 16, which has its bottom 14 conductively coupled to the top of the column reactor 12 to disgregate the liquid from the gas, is hollow and columnar in shape and has its inner wall covered with thin film of polytetrafluoroethylene.

The separating basin 16, which also is circular in horizontal cross-section, has its bottom 14 conductively coupled to the column reactor 12 as well as to the return column cooler 20. The separating basin 16 has a measured quantity dispensing tap 30 provided in its lower side to regulate and feed a flow of the reaction/recycled liquids. For the purpose of pressure reduction within the separating basin 16, an orifice 32 may be provided with a vacuum pump (not shown). At the top of the separating basin 16, as can be seen in FIG. 2, the level gauge orifice 32 (a level gauge is not shown) is centered while a thermometer orifice 34 (a thermometer is not shown) and four gas outlets 36 are all concentrically arranged in the middle of radius segments of the circular top.

The return column cooler 20 is, as shown in FIG. 1, provided with a coolant supply port 40 at its lower side through which coolant composed of any of chlorofluorocarbons is supplied and a coolant drawing port 42 at it upper side through which the coolant of the chlorofluorocarbon is evacuated from the column. The return column cooler 20 is, as shown in a horizontal cross-sectional view of FIG. 3, provided with a plurality of reaction channels 46 in parallel with one another within a hollow cylindrical cooling housing 44 so as to lead the reaction/recycled liquids downward. A flow of coolant, filling clearances among the cooling housing 44 and the reaction channels 46, goes up.

The return column cooler 20 has its lower portion buckled in right-angled L shape to lie horizontal and then further bent up at right angle so as to lead to the bottom of the column reactor 12. The horizontal extension of the return column cooler 20 at the bottom between both the right-angled bends is provided with a thermometer 50 that resides horizontally to determine temperature of the reaction/recycled liquids. An upright end from the right-angled bend ahead of the horizontal extension in the return column cooler 20 at the bottom has a reactant filling/refilling port 54 that is conducting vertically upward to refill the return column cooler 20 with the reaction/recycled liquids that are drawn through the measured quantity dispensing tap 30 and regulated in quantity as much as that of the virgin liquid stock L. The virgin liquid stock L may be fed from the return column cooler 20.

The return column cooler 20 has its part in the vicinity of the column reactor 12 provided with a gaseous material sparging port 60 through which supplied are a reactant gaseous material ClF₃, reaction gas products NF₂Cl and NFCl₂ derived from the reaction chamber, and another reaction gas product NF₃ resulted from further fluorinating the reaction gas products. The reactant gaseous material ClF₃ is a virgin gas newly applied to undergo the reaction for the first time; the reaction gas products NF₂Cl and NFCl₂ are drawn from the gas outlets 36 at the top of the separating basin 16; and NF₃ is derived from the second- or later cycle fluorinating reaction where the reaction gas products NF₂C and NFCL₂ obtained through the gas outlet 36 are further fluorinated. Fluorinating agents used to fluorinate NF₂C and NFCL₂ include fluorine gases such as F₂, ClF₃, and the like, metal fluorides such as CoF₃, and composite metal fluorides such as K₃NiF₇. Alternative to fluorinating NF₂Cl and NFCL₂, they may undergo thermal decomposition to generate NF₃.

As depicted in FIGS. 4 and 5, a reactant gas nozzle 62, which is used to sparge the reactant gaseous materials ClF₃, NF₂Cl, NFCL₂ and NF₃ into the return column cooler 20, is generally hollow and closed only at its distal end, and is provided with a plurality of nozzle apertures 66 that are beveled downward in the vicinity of the distal end. The reactant gas nozzle 62 is attached so that the nozzle apertures 66 are almost centered in a horizontal dimension of a lumen of the return column cooler 20.

### <Operation of the Apparatus>

The above-mentioned fluorinated gas compound generating apparatus 10 is operated in the following manner as detailed below. In the return column cooler 20, the gaseous material (the reactant gas) ClF₃ and the reaction gas products such as NF₂Cl, NFCL₂, NF₃ and the like are sparged into a liquid mixture containing one or more of the reaction/recycled liquids drawn through the measured quantity dispensing tap 30 and regulated in quantity as much as that of the virgin liquid stock L, the virgin liquid stock L (e.g., of NH₄F-nHF), and the reacted liquid stock L cooled in the return column cooler 20. As a consequence, the liquids in the column reactor (i.e., a reaction chamber) gets smaller in apparent relative density and lighter, goes up through the column reactor 12 (i.e., the reaction chamber) while reacting with the gases till it eventually enters the separating basin 16.

One of other examples of the reactant gas is (NH₄)₃AlF₆-nHF. Some of other examples of the liquid stock include ClF, BrF, BrF₃, ClF₅, BrF₅, IF_{S}, and the like.

A quantity of the reaction liquids, namely, a level of the liquids remaining in the separating basin 16 after the reaction is regulated by appropriately opening and closing an adjustment valve (not shown) of the measured quantity dispensing tap 30 in the separating basin 16 and another adjustment valve (not shown) of the reactant filling/refilling port 54 in the return column cooler 20 with reference to an indicated value of the level gauge 32.

In the separating basin 16, the reaction gas products NF₂Cl and NFCl₂ are drawn through four of the gas outlets 36, and part of the reaction gas products is fed as a target product as has been desired to the next stage while the residue is supplied to the gaseous material sparging port 60.

Temperature in the column reactor 12, which is influential upon generation of the fluorinated gas compounds, may be controlled to a desired level such as to 20±5 degrees Celsius by appropriately opening and closing an adjustment valve (not shown) in the coolant supply port 40 with reference to measurements of the thermometers 34, 50 of the separating basin 16 and the return column cooler 20, respectively, so as to regulate supply of the coolant.

### Embodiment 2

FIG. 6 is a side view of the second preferred embodiment of the apparatus 110 of generating fluorinated gas compounds according to the present invention. The fluorinated gas compound generating apparatus 110 is dissimilar to the apparatus 10 of the first embodiment in that a column cooler 124 is located in an area below the bottom of the column reactor into which the virgin gaseous material and the reaction/recycled gas products are sparged. The column cooler 124 may be designed to provide a horizontal cross-section as depicted in FIG. 3. The column cooler 124 works to regulate temperature of the circulating liquids, and hence, there is no need of providing additional cooling unit in a return conduit 122 that is a counterpart member to the return column cooler 20 in FIG. 1.

### DETAILED DESCRIPTION OF PRACTICES

### Experiment 1

A reaction device was prepared in a configuration like that of the fluorinated gas compound generating apparatus 10 in FIG. 1. The liquid stock L (NH₄F-2.0HF) was added through the reactant filling/refilling port 54 to fill the column reactor and flow into the separating basin 16 till the liquid level came up to the middle of the basin. A quantity of the liquid stock L to fill this much was about 35 litters. The liquid stock L was timely refilled by an amount of the liquid reacted and reduced through the reactant filling/refilling port 54.

The virgin gas material ClF₃ started and continued reaction while being sparged at flow rate of 4 SLM through the gaseous material sparging port 60 to draw the reaction gas products NF₂Cl and NFCl₂ derived from the reaction through the gas outlets 36 although part of the reaction gas products returned trough pipes (made of SUS304) not shown in the drawings to the gaseous material sparging port 60. The flow rate of the reaction gas product sparged through the port 60 ranged from 40 to 60 SLM.

During the reaction, the returning liquids, cooled while it flew through the return column cooler, regulated the liquid in the refilled separating basin 16 to temperature ranging 19 to 25 degrees Celsius.

No trouble was observed during and 240 hours after the apparatus was actuated by supplying it with the virgin gaseous material and the reaction/recycled gas products through the gaseous material sparging port 60.

### Experiment 2

The reaction device was prepared in a configuration like that of the fluorinated gas compound generating apparatus 10 in FIG. 1. The liquid stock L (NH₄F-2.0HF) was added through the reactant filling/refilling port 54 to fill the column reactor and flow into the separating basin 16 till the liquid level came up to the middle of the basin. A quantity of the liquid stock L to fill this much was about 35 litters. The liquid stock L was timely refilled by an amount of the liquid reacted and reduced through the reactant filling/refilling port 54.

The virgin gas material ClF₃ started and continued reaction while being sparged at flow rate of 0.4 SLM through the gaseous material sparging port 60 to draw the reaction gas products NF₂Cl and NFCl₂ derived from the reaction through the gas outlets 36 so that the whole quantity of the reaction gas products thus collected underwent additional reaction described as ‘further fluorinating the reaction gas products’, which produced ‘second-cycle gas product NF₃’, which in turn partially returned trough pipes (made of SUS304) not shown in the drawings to the gaseous material sparging port 60. The flow rate of the reaction gas product sparged through the port 60 ranged from 40 to 60 SLM. In this flow of the gaseous material, 5 to 6 SLM is of ClF₃ gas remaining unreacted. With the reactant gaseous material containing the unreacted and recycled ClF₃ gas portion, approximately 4 SLM alone might get really reactive in the succeeding reaction cycle.

During the reaction, the returning liquids, cooled while it flew through the return column cooler, regulated the liquid in the refilled separating basin 16 to temperature ranging 19 to 25 degrees Celsius.

No trouble was observed during and 240 hours after the apparatus was actuated by supplying it with the virgin gaseous material and the reaction/recycled gas products through the gaseous material sparging port 60. Also, in the course of the reaction, the reaction gas product immediately after being retrieved through the gas outlets 36 had its composition analyzed. The analysis results are provided in Table 1 as below. In contrast with Comparison 1 detailed later, a smaller percentage of N₂ in the gas product was observed.

TABLE 1

| N₂ | NF₃ | Other | N₂/NF₃ |
|---|---|---|---|
| 6% | 62% | 32% | 0.10 |

### Comparison 1

The reaction device was prepared in a configuration like that of the fluorinated gas compound generating apparatus 10 in FIG. 1. The liquid stock L (NH₄F-2.0HF) was added through the reactant filling/refilling port 54 to fill the column reactor and flow into the separating basin 16 till the liquid level came up to the middle of the basin. A quantity of the liquid stock L to fill this much was about 35 litters. The liquid stock L was timely refilled by an amount of the liquid reacted and reduced through the reactant filling/refilling port 54.

The virgin gas material ClF₃ started and continued reaction while being sparged at flow rate of 4 SLM through the gaseous material sparging port 60 to draw the reaction gas products NF₂Cl and NFCl₂ derived from the reaction through the gas outlets 36 although part of the reaction gas products thus collected returned trough pipes (made of SUS304) not shown in the drawings to the gaseous material sparging port 60. The flow rate of the reaction gas product sparged through the port 60 ranged from 40 to 60 SLM.

During the reaction, the returning liquids, cooled while it flew through the return column cooler, regulated the liquid in the refilled separating basin 16 to temperature ranging 19 to 25 degrees Celsius.

The residue of the reaction gas products NF₂Cl and NFCl₂ immediately after being retrieved through the gas outlets 36 and not returned for recycle to the gaseous material sparging port 60 underwent a treatment of reacting with F₂ in an additional reaction chamber to generate NF₃. It was observed that yield of the reacted per the reactant was 100%. The reaction gas derived through the gas outlets 36 had its composition analyzed. The analysis results are provided in Table 2 as below.

In contrast with Experiment 2, as will be recognized, a greater percentage of N₂ in the reaction gas retrieved through the gas outlets 36 was observed. 100% yield of NF₃ composed from NF₂CL, NFCl₂, and N₂ explains a cause of this degraded effect than in Experiment 2.

TABLE 1

| N₂ | NF₃ | Other | N₂/NF₃ |
|---|---|---|---|
| 3% | 22% | 75% | 0.14 |

### BRIEF DESCRIPTION OF THE DRAWINGS

FIG. 1 is a side view of a first embodiment of an apparatus of generating fluorinated gas compounds (10).

FIG. 2 is a plan view of the exemplary fluorinated gas compound generating apparatus (10).

FIG. 3 is a horizontal sectional view showing a return column cooler (20, 124).

FIG. 4 is a sectional view of an enlarged part of a gaseous material sparging port in FIGS. 1 and 6.

FIG. 5 is a vertical sectional view of a reactant gaseous material supply nozzle.

FIG. 6 is a side view of another or a second embodiment of the apparatus of generating fluorinated gas compounds (110).

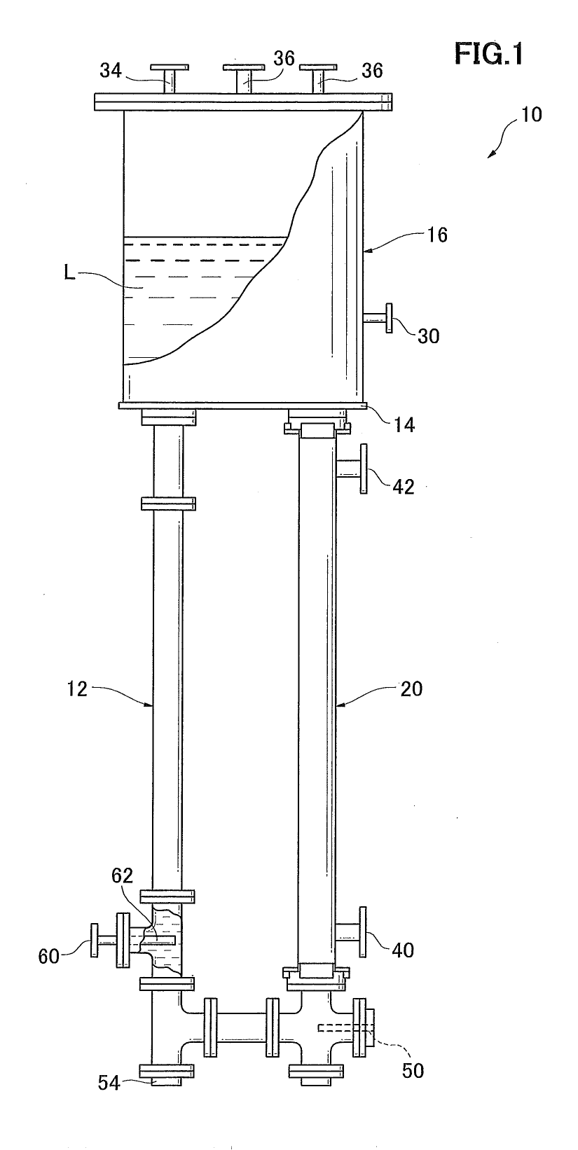

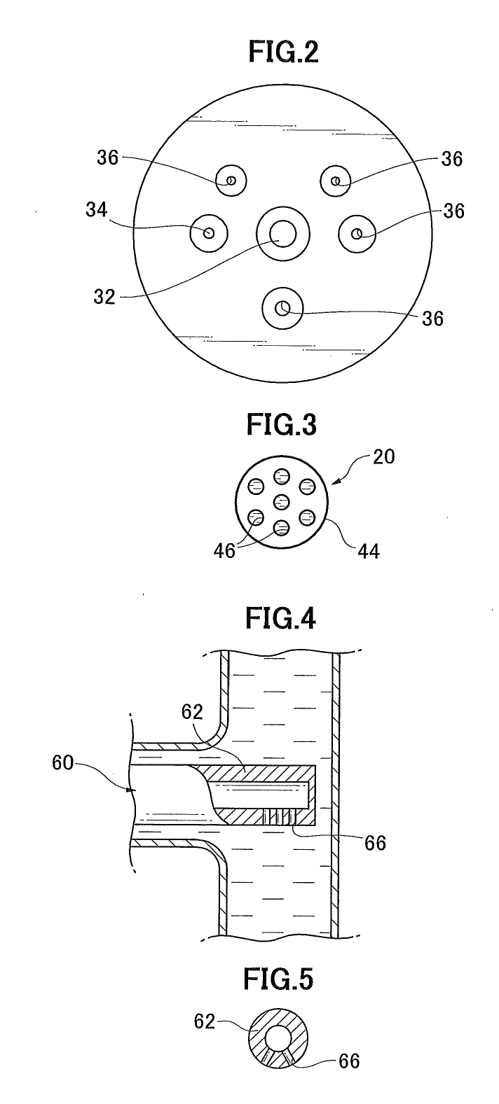

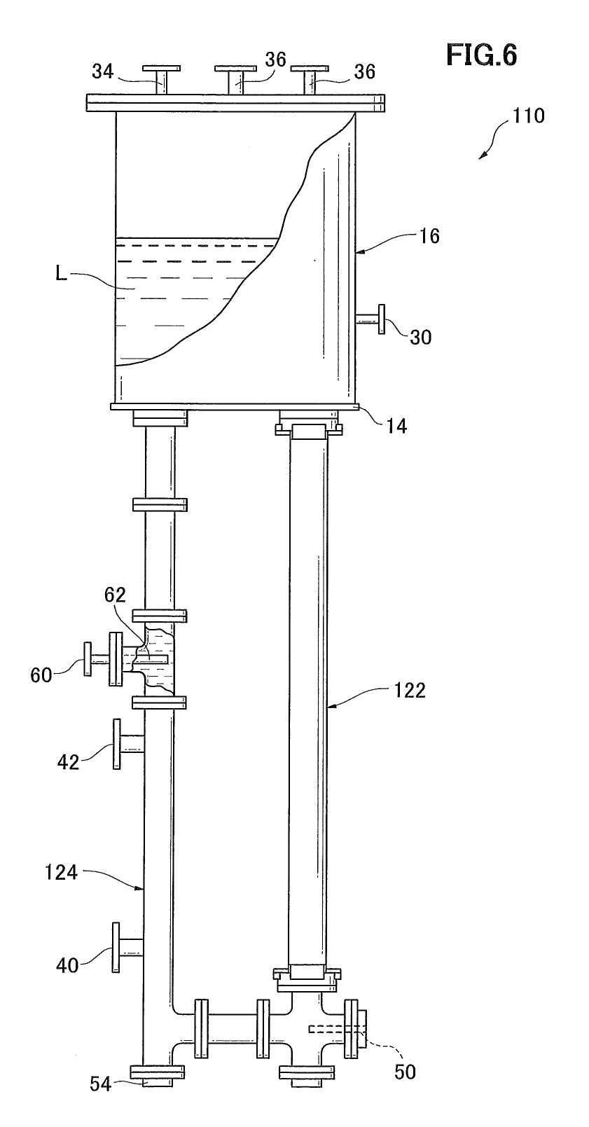

### DESCRIPTION OF REFERENCE NUMERALS

L Liquid Stock
10 Fluorinated Gas Compound Generating Apparatus
12 Column Reactor
14 Bottom of Basin
16 Separating Basin
20 Return Column Cooler
30 Measured Quantity Dispensing Tap
32 Level Gauge Orifice
34 Thermometer Orifice
36 Gas Outlets
40 Coolant Supply Port
42 Coolant Drawing Port
44 Cooling Housing
46 Reaction Channels
50 Thermometer
54 Reactant Filling/Refilling Port
60 Gaseous Material Sparging Port
62 Reactant Gas Nozzle
66 Nozzle Apertures
110 Fluorinated Gas Compound Generating Apparatus
122 Return Conduit
124 Cooling Column

1. A method of generating fluorinated gas compounds by means of reacting liquid stock with gaseous material comprising:
providing a circulating system comprised of a reaction chamber where a liquid mixture containing the liquid stock reacts with the gaseous material, a fluid conduit through which the liquid mixture alone flows, an upper fluid channel through which the reacted liquid mixture moves from the top of the reaction chamber to the top of the fluid conduit, and a lower fluid channel through which the liquid mixture moves from the bottom of the fluid conduit to the bottom of the reaction chamber, and
sparging into the bottom of the reaction chamber (A) the virgin gaseous material and (B) at least one selected from the fluorinated gas compounds resulted from the reaction in the reaction chamber, including the first fluorinated gas product generated in the first cycle of the reaction and the second or later gas product resulted from further fluorinating the first or later gas product in the succeeding cycle, so as to circulate the liquid mixture.

2. The method of generating fluorinated gas compounds according to claim 1, wherein the liquid mixture undergoes temperature adjustment in the fluid conduit or a region below the reaction chamber.

3. The method of generating fluorinated gas compounds according to claim 1, wherein the gaseous material includes interhalogenated substances.

4. The method of generating fluorinated gas compounds according to claim 1, wherein the liquid stock includes complex compounds.

5. The method of generating fluorinated gas compounds according to claim 1, wherein the second fluorinated gas product is fully fluorinated or includes reaction-completed fluorides.

6. An apparatus of generating fluorinated gas compounds by means of reacting liquid stock with gaseous material comprising:
providing a circulating system comprised of a reaction chamber where a liquid mixture containing the liquid stock reacts with the gaseous material, a fluid conduit through which the liquid mixture alone flows, an upper fluid channel through which the reacted liquid mixture moves from the top of the reaction chamber to the top of the fluid conduit, and a lower fluid channel through which the liquid mixture moves from the bottom of the fluid conduit to the bottom of the reaction chamber, and
providing a gas port unit through which sparged into the bottom of the reaction chamber are the virgin gaseous material and at least one selected from the fluorinated gas compounds resulted from the reaction in the reaction chamber, including the first fluorinated gas product generated in the first cycle of the reaction and the second or later gas product resulted from further fluorinating the first or later gas product in the succeeding cycle.

7. The apparatus of generating fluorinated gas compounds according to claim 6, further comprising a liquid temperature regulating means by which the liquid mixture undergoes temperature adjustment in the fluid conduit or a region below the reaction chamber.
